(19) United States
(12) Patent Application Publication
(10) Pub. No.: US 2022/0333420 A1
(43) Pub. Date: Oct. 20, 2022

(54) SOFT-CLOSE SYSTEM FOR A SLIDING DOOR

(71) Applicant: Hoskin & Muir, Inc., Louisville, KY (US)

(72) Inventor: Jason S. Willis, Louisville, KY (US)

(21) Appl. No.: 17/659,354

(22) Filed: Apr. 15, 2022

Related U.S. Application Data
(60) Provisional application No. 63/201,156, filed on Apr. 15, 2021.

(51) Int. Cl. E05F 5/02; E05F 5/00

(52) U.S. Cl. CPC E05F 5/02; E05F 5/003; E05Y 2201/224; E05Y 2201/684; E05Y 2201/688; E05Y 2600/626; E05Y 2900/132

(57) ABSTRACT

A sliding door having a soft-close system, with the sliding door having one or more sliding door panels and having a soft-close bracket. The soft-close bracket includes a soft-close device secured to a door panel and movable within a support rail. The soft-close device is engaged with a stopper in the support rail. Also provided are associated methods for retrofitting a soft-close system to an existing sliding door.

### CROSS-REFERENCE TO RELATED APPLICATIONS

This application is a nonprovisional and claims the benefit of U.S. Patent Application Ser. No. 63/201,156 filed Apr. 15, 2021, which is hereby incorporated by reference in its entirety for any purpose whatsoever.

### TECHNICAL FIELD

The present disclosure relates to a soft-close system for a sliding door and, in certain embodiments, to a soft-close system configured for retrofit installation within an existing sliding door.

### BACKGROUND

Conventional sliding doors can suffer from deficiencies inherent in the mechanism by which the sliding doors are mounted within a door frame. Namely, because sliding doors operate by employing a user's force to accelerate the door laterally to open or close the door, sliding doors can potentially suffer structural stress (e.g., breaking of glass doors). Moreover, conventional sliding doors can potentially suffer such further deficiencies as producing loud noises when closed abruptly, or disengaging from a door frame when accelerated too fast during use. It is known to employ a soft-close system to prevent such abrupt opening and closing and provide a more luxurious user experience. However, these conventional soft-close systems are yet themselves deficient.

Conventional soft-close systems for sliding doors have sought to remedy the above deficiencies of sliding doors by employing either a pneumatic or a hydraulic cylinder to cushion and decelerate the sliding door during its lateral motion. Despite these and other observed advantages, inefficiencies can also arise with the use of conventional soft-close systems for sliding doors. For example, because conventional soft-close systems have not contemplated use with existing sliding doors, there comes the dilemma of finding room within a support rail to dispose the often bulky conventional soft-close system. And, even then, use of a soft-close system within an existing sliding door requires extensive efforts, including disassembly of the existing sliding door and reassembly of the sliding door with the soft-close system. Oftentimes, however, such existing sliding doors are not even compatible with soft-close systems. Indeed, these phenomena negatively impact the ability of soft-close products to deliver expected consumer performance and expected manufacturer performance, and to avoid waste. Therefore, a need exists for a soft-close system for a sliding door having the below described manufacturing and configuration advantages, and retrofit capabilities.

### BRIEF SUMMARY

To address the difficulty of providing a soft-close system for use in an existing sliding door, along with other technical considerations, there is described herein according to various embodiments a soft-close system comprising: a support rail, the support rail being fitted with one or more soft-close door stoppers and a snap-in retainer; and one or more soft-close devices.

According to various embodiments there is also described a method of installing a soft- close system, the method comprising the steps of: fastening one or more soft-close door stoppers to a support rail, wherein a first soft-close door stopper is offset nearer to a first lateral edge of the support rail, and a second soft-close door stopper is offset nearer to a second lateral edge of the support rail; installing a first soft-close device on a first panel of a sliding door, the first soft-close device being configured in line with a first roller and roller bracket of the sliding door; installing a second soft-close device on a second panel of the sliding door, the second soft-close device being configured in line with a second roller and roller bracket of the sliding door; and installing the first panel and the second panel of the sliding door with the first soft-close device and the second soft-close device mounted thereto within the support rail, wherein the first soft-close device and the second soft-close device are oriented according to the respective sliding orientation of the first panel and the second panel.

### BRIEF DESCRIPTION OF THE DRAWINGS

The invention is described in detail below with reference to the drawings wherein like numerals designate similar parts.

FIG. 1 illustrates a conventional sliding door.

FIG. 2 illustrates a front perspective view of a support rail of a soft-close system for a sliding door according to various embodiments.

FIGS. 2A-2B illustrate magnified sectional views of a support rail of a soft-close system for a sliding door according to various embodiments.

FIG. 2C illustrates a sectional view of a roller and roller bracket and one or more soft- close door stoppers installed in a support rail according to various embodiments.

FIGS. 3A-3B illustrate isolated views of sliding doors fitted with the soft-close devices according to various embodiments.

FIG. 3C is a perspective view of a soft-close device installed in a support rail according to various embodiments.

FIG. 3D is a sectional view of two soft-close devices installed in a support rail according to various embodiments.

FIG. 3E is a sectional view of a soft-close device and a snap-in retainer installed in a support rail according to various embodiments.

FIG. 4 illustrates an exemplary method of installing a soft-close device according to various embodiments.

### DETAILED DESCRIPTION

The invention is described in detail below in connection with the various figures and for purposes of illustration. It should be understood, though, that only some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Still further, terminology used throughout herein is given its ordinary meaning, except as supplemented immediately below, and like numbers refer to like elements throughout.

“Handedness” or similar terminology refers to the direction by which a sliding door system opens, as seen by an outside observer. Moreover, various sliding door systems make use of one or more center panels, which translate laterally (e.g., slide left, slide right, or slide toward the center) to open and close the sliding door while the left-most and right-most panels remain fixed. Accordingly, the invention described herein may be employed with respect to sliding door systems configured as either: a left-handed (open-left) sliding door, a right-handed (open-right) sliding door, or a sliding door system employing one or more center panels.

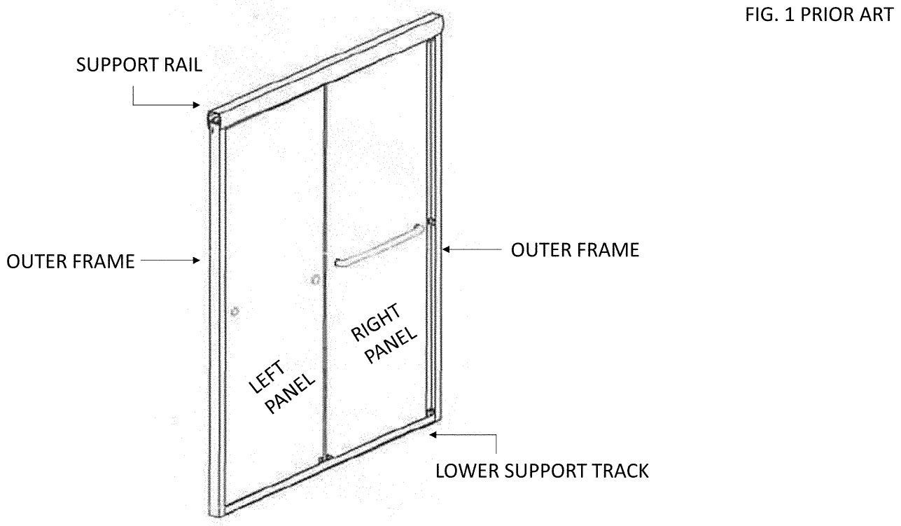

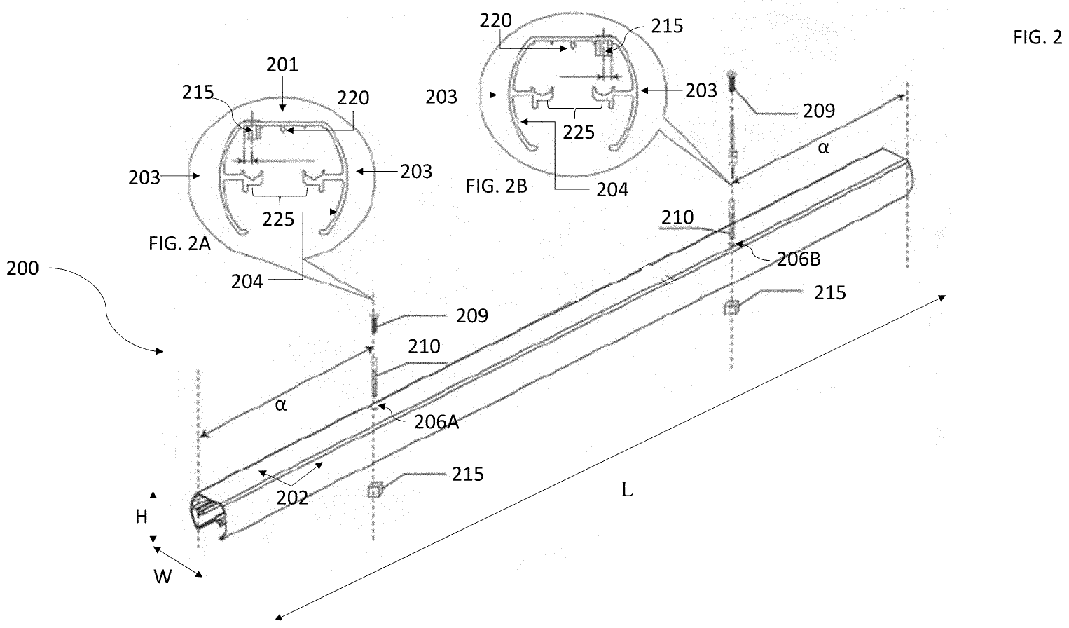

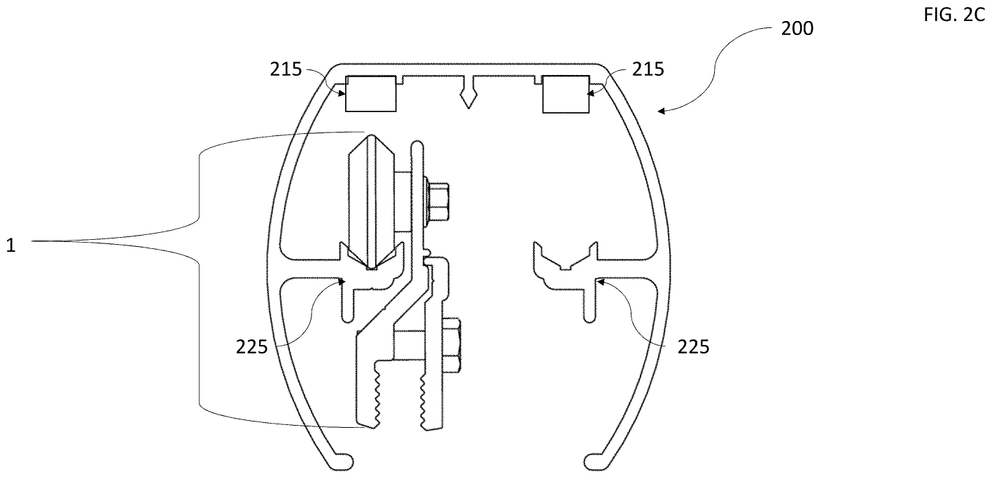

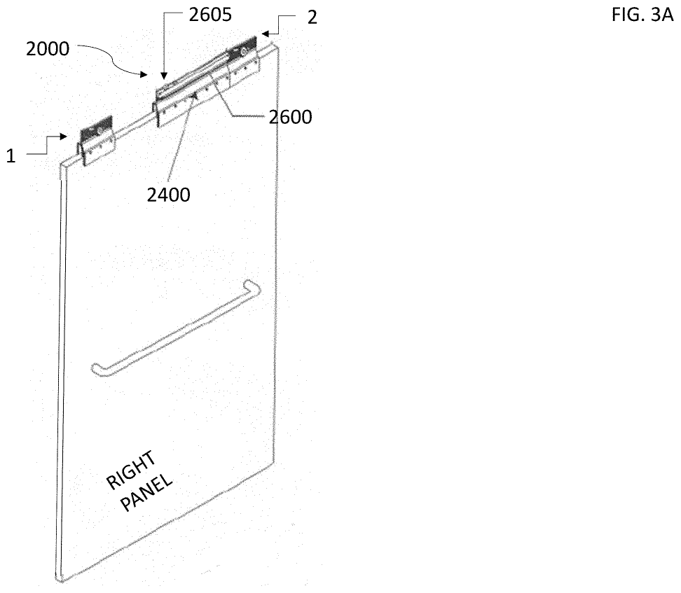

Referring first to FIGS. 1-2B in combination, a sliding door system is illustrated (see FIG. 1) with particular attention being given to a support rail 200 of various embodiments (see FIGS. 2-2B). As is illustrated in the conventional system of FIG. 1, a sliding door comprises two panels (i.e., doors), and typically comprises a lower support track. As a matter of style, any sliding door system may be configured so that only one panel is moveable, or both panels may be moveable. For example, the conventional sliding door illustrated in FIG. 1 is configured so that a right-most panel is moveable, with a left-most panel that is also moveable, though either the left-most panel or the right-most panel could alternatively be fixed in position. The lower support track facilitates the opening and closing of the door(s) by housing the bottom of each panel such that only lateral movement is possible. A conventional sliding door may further comprise an outer frame, such as a metal frame, and a support rail. Each the outer frame and the support rail serve to support the weight of the two (or more) panels, while the support rail also further facilitates the opening and closing of the door(s) in conjunction with the lower support track.

As is evident from FIG. 2, the support rail 200 of a soft-close system according to various embodiments defines a substantially prismatic shape characterized by: a top face 201 (shown in FIG. 2A) that is generally planar, and two opposing arcuate faces 203 (shown in FIGS. 2A and 2B) descending therefrom. In embodiments, the support rail 200 is formed from extruded aluminum or other suitable material(s) and through any suitable means or process (e.g., hot extrusion, cold extrusion, warm extrusion, friction extrusion, micro-extrusion, drawing and/or the like) whereby the advantages of the present disclosure, such as providing an appropriate cross-sectional profile and surface finish, may be realized.

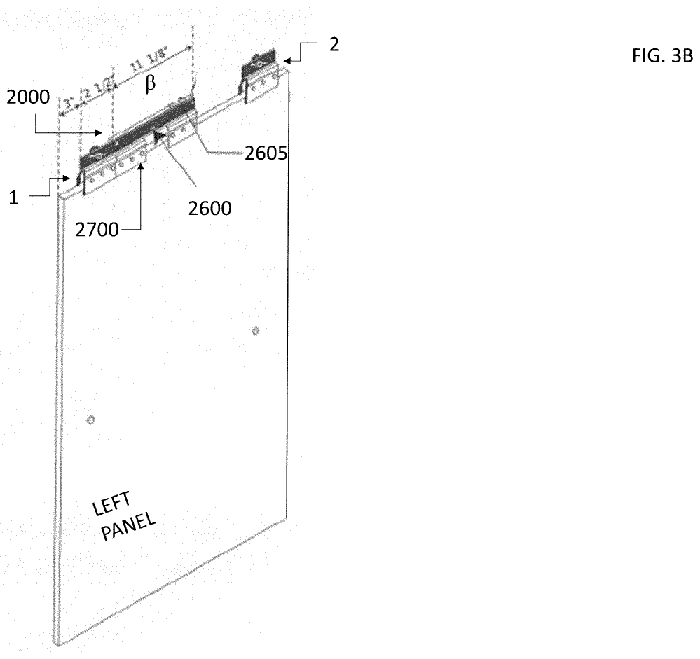

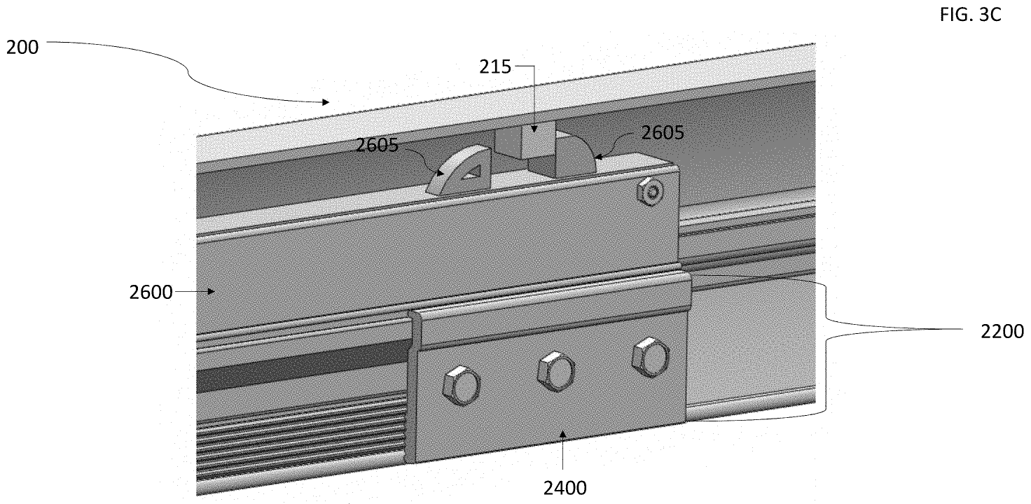

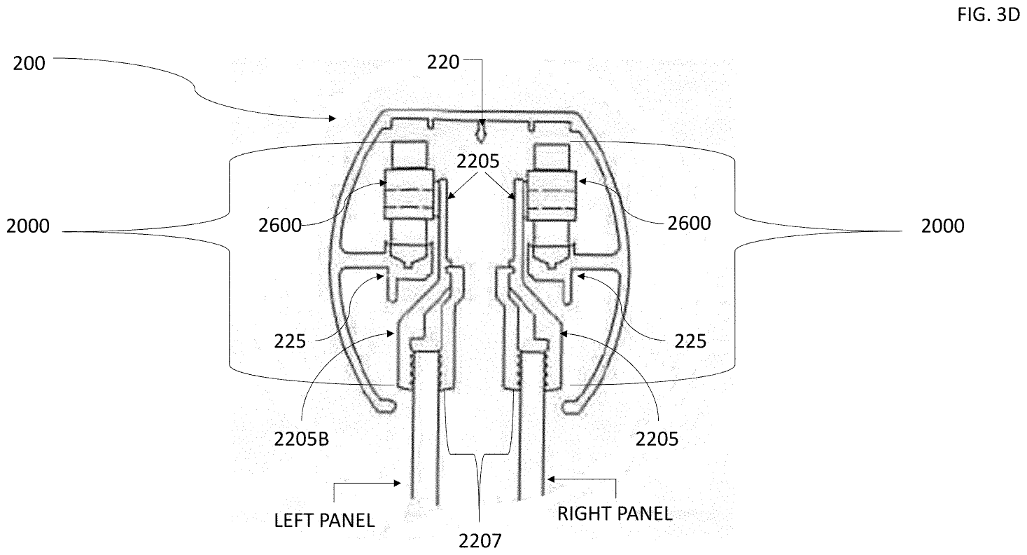

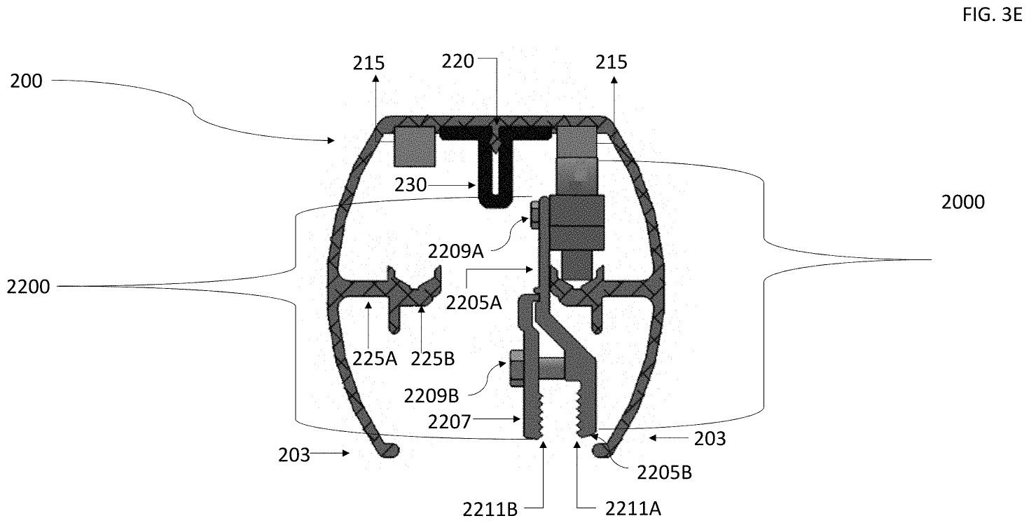

Together, the top face 201 and the two arcuate faces 203 define an outer surface 202 and an inner surface 204 (discussed below in greater detail with reference to FIGS. 2A, 2B, and 3D) of the support rail 200. The support rail 200 is characterized largely by its length, L, width, W, height, H, and substantially hexagonal cross-section. As illustrated, one or more soft-close door stoppers 215 may be fastened or otherwise secured to the inner surface 204 of the support rail 200 by one or more stopper fasteners 209. The soft-close door stoppers 215 may be advantageously secured to the inner surface 204 from above, so as to reduce visibility of various hardware implements and maintain a desired pleasant aesthetic. For example, one or more mounting recesses 206 may be formed in the outer surface 202, at the top face 201 by a boring or drilling implement, such as one or more drill bits 210 for the purpose of securing the one or more soft-close door stoppers 215.

In various embodiments, the one or more soft-close door stoppers 215 are substantially cubic in shape. The one or more soft-close door stoppers 215 may each comprise receiving holes for receiving the one or more stopper fasteners 209. In various embodiments, a receiving hole of the one or more soft-close door stoppers 215 is centered on a vertical axis defined relative to a first face of the one or more soft-close door stoppers 215. The receiving hole may be threaded to receive the one or more stopper fasteners 209. In certain embodiments, the one or more soft-close door stoppers 215 are characterized by a width or thickness of at least 5/32 of an inch. In at least one embodiment, the one or more soft-close door stoppers 215 are characterized by a thickness of approximately 10/32 of an inch, wherein a receiving hole is thus centered on a vertical axis defined a lateral distance of 5/32 of an inch from any lateral edge of the one or more soft-close door stoppers 215.

As shown, the one or more mounting recesses 206 may each be formed at a distance α from respective ends of the support rail 200. In embodiments, a first mounting recess 206A may be formed at a distance a from a first end of the support rail 200, while a second mounting recess 206B is formed at a distance a from a second end thereof. In certain embodiments, the distances a are the same. However, in alternative embodiments the distances α may be different. In at least one embodiment, the first mounting recess 206A and the second mounting recess 206B are each formed at a distance, α, of approximately 15.75 inches from respective ends of the support rail 200. Further as shown, the one or more mounting recesses 206 are respectively offset from a central axis of the support rail 200 so that the first mounting recess 206A is nearer to a first lateral edge of the support rail 200, while the second mounting recess 206B is nearer to a second lateral edge thereof. This offset feature of the one or more mounting recesses 206 accommodates a handedness of various embodiments as discussed further below, and is also shown in greater detail with reference to FIGS. 2A-2B.

FIGS. 2A and 2B illustrate magnified sectional views of a support rail 200 of a soft-close system according to various embodiments. Particularly, FIGS. 2A and 2B illustrate in greater detail the advantageous cross-sectional profile of the support rail 200. As evident, the inner surface 204 of the support rail 200 is characterized by one or more retainer engaging elements 220. The one or more retainer engaging elements 220 may be one or more extrusions, grooves, or other formations defined in the inner surface 204, at the top face 201, that are configured to engage and secure the snap-in retainer 230 to the inner surface 204 (see FIG. 3E). In at least one embodiment, the one or more retainer engaging elements 220 are configured to secure an existing snap-in retainer of an existing sliding door system to the inner surface 204.

The inner surface 204 is further characterized by a set of guiding channels 225. The guiding channels 225 facilitate lateral movement of a sliding door by housing one or more rollers (i.e., a roller and a corresponding roller bracket). In the embodiment illustrated, the set of guiding channels comprises two guiding channels 225. The set of guiding channels 225 extend inward toward one another from a medial aspect of the interior surface 204. The snap-in retainer 230 serves to retain the door panels in place on the set of guiding channels 225 after they have been hung on the support rail 200.

Turning now briefly to FIG. 2C, therein is illustrated a sectional view of a first roller and first roller bracket 1, and soft-close door stoppers 215 installed in a support rail 200. As shown, the set of guiding channels 225 are configured to support the first roller and first roller bracket 1. The set of guiding channels 225 each extend the length of the support rail 200, and define a substantially planar portion 225A and a recess portion 225B. The recess portion 225B is configured to stably engage the roller of the roller and roller bracket 1. For example, the roller of the roller and roller bracket 1 may be rounded or v-shaped to match a cross-sectional profile of each recess portion 225B. In this way, the set of guiding channels 225 allow only lateral motion of a door panel. Furthermore, when in situ, the soft-close device 2000 is disposed in line with the existing rollers and roller brackets (see FIGS. 3A-3B) of a sliding door system in otherwise unused space within a support rail (e.g., an existing support rail). This can be further seen in FIG. 3E where a portion of the soft-close device 2000 fits within the recess portion 225B. These components may or may not be touching each other, but a substantial portion of the weight of the doors is carried by the rollers rolling in the guiding channels 225, as seen in FIG. 2C. Thus, a soft-close device 2000 of various embodiments is configured having an advantageous spatial footprint.

As may also be appreciated from the views of FIGS. 2A-2C, a first soft-close door stopper 215 is disposed above a corresponding first guiding channel 225. Likewise, a second soft-close door stopper 215 is disposed above a corresponding second guiding channel 225. In this way, each soft-close door stopper 215 is respectively offset from a central axis of the support rail 200, so as to engage a corresponding soft-close device 2000 (see FIGS. 3C and 3E) in a one-to-one manner when fitted therein. For example, each soft-close door stopper 215 is shown offset so that a central vertical axis thereof is disposed a further distance from one arcuate face 203 than the other arcuate face 203. As discussed above, in at least one embodiment, a central vertical axis of each soft-close door stopper 215 is disposed a distance of 5/32 of an inch from the nearer arcuate face 203. When fitted there in the guiding channel 225, the soft-close device 2000 will abut the soft-close door stopper 215 (see FIGS. 3C and 3E).

Turning now to FIGS. 3A-3E in combination, illustrated therein are various views of the soft-close device 2000 installed in a sliding door according to various embodiments. The embodiment illustrated in FIG. 3A shows the soft-close device 2000 advantageously disposed intermediate the first roller and first roller bracket 1 and a second roller and second roller bracket 2 of an existing sliding door system. For example, as discussed above with reference to FIG. 1, sliding door systems usually employ some mechanism, such as rollers, roller brackets, a support rail and a support track to facilitate opening and closing (i.e., “sliding” of a door).

In various embodiments, the soft-close device 2000 is configured to abut a roller and roller bracket that is nearest to a wall. Thus, for example, FIG. 3A shows the soft-close device 2000 installed on a right panel of a two-panel sliding door system, abutting the right-most roller and roller bracket (e.g., the second roller and second roller bracket 2) accordingly. With quick reference to FIG. 3B, a corresponding second soft-close device 2000 may be seen installed on the corresponding left panel to abut the left-most roller and roller bracket 1. As shown, the soft-close device 2000 of various embodiments can be used for either door. An exterior facing surface 2400 is presented and visible when installed on a right panel of a right-open sliding door system (e.g., as shown in FIG. 3A). Likewise, when installed on a left panel of a sliding door system, an interior facing surface 2700 is presented and visible. However, use in an oppositely-oriented sliding door system (i.e., a left-open sliding door) may be achieved by assembling the soft-close device 2000 itself in an opposite orientation to that just now described.

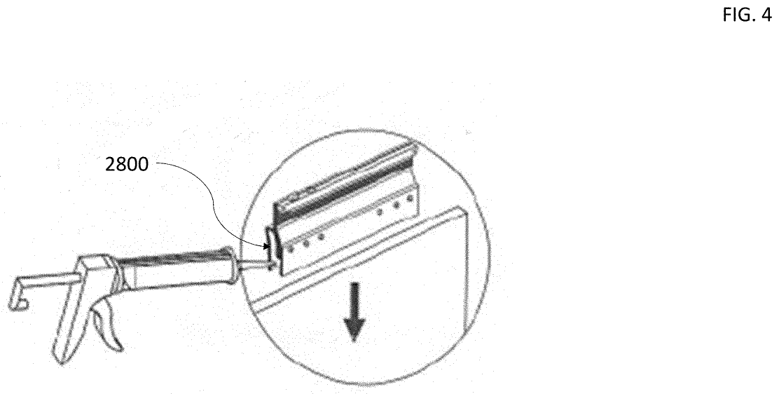

Generally, the soft-close device 2000 comprises a soft-close bracket 2200 (see FIGS. 3C and 3E), a soft-close mechanism housing 2600, and a mounting channel 2800 (see FIG. 4). The soft-close bracket 2200 comprises the exterior facing surface 2400 and the interior facing surface 2700 (i.e., as seen by an outside observer). Advantageously, the soft-close bracket 2200 of various embodiments may be configured having the same extrusion profile as the roller brackets typically used in sliding door systems (e.g., the first roller and first roller bracket 1 and the second roller and second roller bracket 2). In this way manufacturing costs are reduced and a uniform (and therefore aesthetically pleasing) appearance maintained. Moreover, in at least one embodiment wherein the soft-close bracket 2200 and the roller brackets share an extrusion profile, the soft-close bracket 2200 may be configured having a length, β, that is longer than a length of the existing roller brackets (see FIG. 3B). In certain embodiments, the length β may range from approximately 10.625 inches to 11.625 inches. In at least one embodiment, the length β may be approximately 11.125 inches.

Referring to FIG. 3C, a perspective view of a soft-close device installed in a support rail 200 is illustrated. In various embodiments, a soft-close mechanism housing 2600 houses an elastic component, such as a spring and damper system, that is configured to decelerate the motion of a sliding door. In at least one embodiment, the elastic component further comprises one or more retractable engagement portions 2605 that engage or disengage the one or more soft-close door stoppers 215 to load/unload the elastic component. For example, a surface of the soft-close mechanism housing 2600 may define a recess through which the one or more retractable engagement portions 2605 may engage or disengage the one or more soft-close door stoppers 215.

Turning now to FIGS. 3D-3E in combination, illustrated therein are sectional views of a soft-close device 2000 according to various embodiments. Illustrated descending from a lateral aspect of the soft-close mechanism housing 2600 is the soft-close bracket 2200 (see FIG. 3E). The soft-close bracket 2200 generally defines a first descending extension, such as the first descending extension 2205. The first descending extension 2205 may be fixed or otherwise secured to the soft-close mechanism housing 2600 by one or more fasteners, such as the one or more fasteners 2209A (see FIG. 3E). The first descending extension 2205 comprises a vertical portion 2205A (see FIG. 3E) and an angled portion 2205B, wherein the angled portion 2205B juts or extends laterally from the vertical portion 2205A. Substantially near to the point or location where the angled portion 2205B extends from the vertical portion 2205A, a second descending extension 2207 may extend from a lateral aspect the first descending extension 2205. For example, the second descending extension 2207 may be fixed or otherwise secured to the first descending extension, or may be integral therewith.

Taking reference now to FIG. 3E to further illustrate the soft-close bracket 2200, it may be seen that the first descending extension 2205 together with the second descending extension 2207 are advantageously configured engage a panel (e.g., a glass panel) of a sliding door system. In the embodiment illustrated, for example, the first descending extension 2205 and the second descending extension 2207 both define a set of panel engaging teeth configured to engage a first surface and a second surface of a panel in a sliding door system. The first panel engaging teeth 2211A are defined in a first surface of the angled portion 2205B. A corresponding set of panel engaging teeth, second panel engaging teeth 2211B, are defined in a first surface of the second descending extension 2207. Furthermore, one or more panel width adjustment holes are defined in the second descending extension 2207 and the angled portion 2205B. These panel width adjustment holes are configured to receive one or more corresponding panel width fasteners, such as one or more panel width fasteners 2209B. In this way, the one or more panel width fasteners 2209B may adjust a distance between the first panel engaging teeth 2211A and the second panel engaging teeth 2211B, so that it corresponds to a width of the panel to which the soft-close device 2000 (i.e., the soft-close bracket 2200) is engaged. In various embodiments, the one or more panel width adjustment holes comprise three or more panel width adjustment holes. In certain embodiments, the one or more panel width adjustment holes comprise at least six panel width adjustment holes.

With reference now to FIG. 4, illustrated therein is an advantageous method of installing the soft-close device 2000 on a panel (e.g., a glass door panel) of a sliding door. In certain embodiments, the soft-close device may be retrofitted with an existing glass door. In others, the soft-close device can be included with the package supplied by the manufacturer for a new door system along with the other hardware such as the illustrated rollers and roller brackets. Advantageously, the soft-close device 2000 disclosed herein can be used for both retrofit and new applications. As discussed above, the soft-close device 2000 comprises a mounting channel 2800. The mounting channel generally defines a mounting surface by which the soft-close device 2000 may be mounted or otherwise secured to a panel of a sliding door system. The mounting surface defined by the mounting channel 2800 is configured to receive an adhesive such as silicone, caulk, or other suitable sealant/adhesive or the like. For example, the mounting channel 2800 spans the length β of the soft-close device 2000 such that a suitable sealant/adhesive or the like may be applied within the mounting channel 2800, along the entire length. Subsequent to receiving a suitable adhesive therein, the soft-close device 2000 is configured to be installed on a door panel so that the mounting channel 2800 (i.e., the mounting surface) abuts, engages, or otherwise contacts the door panel along its width and length in order to initiate a sufficient bond for stable support of the door panel. As illustrated by the downward pointing arrow, an appropriate downward force may be applied to ensure sufficient bonding of the soft-close device 2000 and the door panel to one another. Subsequently, as discussed above with reference to FIG. 3E, one or more panel width fasteners 2209B may be used to further secure or fix the soft-close device 2000 to the panel (i.e., by adjusting a distance between the first panel engaging teeth 2211A and the second panel engaging teeth 2211B).

Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A sliding door having a soft-close device, the sliding door comprising:
one or more sliding door panels;
a support rail secured to support at least part of the weight of the door panels, the support rail comprising,
one or more guiding channels,
and at least one soft-close door stopper;
one or more roller brackets for supporting at least one of the door panels, the roller brackets comprising,
at least one descending extension for engaging the door panel, and
at least one roller for rolling in one of the guiding channels as the respective door panel slides; and
at least one soft-close bracket, the soft-close bracket comprising,
at least one descending extension for engaging the door panel, and
a soft-close device secured to the descending extension and movable along the support rail as the respective door panel slides and engageable with a door stopper.

2. The sliding door according to claim 1 wherein the soft-close device fits at least partially within the guiding channel for the respective rollers.

3. The sliding door according to claim 2 wherein the soft-close device does not touch the guiding channel.

4. The sliding door according to claim 1 wherein at least one of the roller brackets is formed as an extrusion and defines an extrusion profile, and wherein the at least one soft-close bracket is formed as an extrusion and defines an extrusion profile, and where the extrusion profiles of the roller bracket and the soft-close bracket are substantially the same.

5. The sliding door according to claim 1 wherein the soft-close device comprises at least one retractable engagement portion.

6. The sliding door according to claim 1 comprising two sliding door panels.

7. The sliding door according to claim 1 comprising two roller brackets for supporting a door panel.

8. The sliding door according to claim 7 wherein the at least one soft-close bracket is positioned between the two roller brackets.

9. A retrofittable soft-close system for a sliding door having a support rail and one or more sliding door panels supported by the support rail, the retrofittable soft-close system comprising:
at least one soft-close door stopper secured to the support rail; and
at least one soft-close bracket, the soft-close bracket comprising,
at least one descending extension for engaging the door panel, and
a soft-close device secured to the descending extension and movable along the support rail as the respective door panel slides and engageable with the door stopper.

10. The retrofittable soft-close system according to claim 9 wherein the soft-close device fits at least partially within a guiding channel of the support rail a roller.

11. The retrofittable soft-close system according to claim 10 wherein the soft-close device does not touch the guiding channel.

12. The retrofittable soft-close system according to claim 9 wherein the soft-close device comprises at least one retractable engagement portion.

13. The retrofittable soft-close system according to claim 9 wherein the at least one soft-close bracket is positioned between two roller brackets that support a respective door panel.

14. A method of retrofitting a soft-close system to an existing sliding door having a support rail and one or more sliding door panels supported by the support rail, the method of retrofitting a soft-close system comprising:
securing at least one soft-close door stopper to the support rail; and
securing at least one soft-close bracket to the door panel, the soft-close bracket having at least one descending extension for engaging the door panel and a soft-close device secured to the descending extension, the securing step comprising;
engaging the descending extension to the door panel so that the soft-close device is movable along the support rail as the respective door panel slides and engageable with the door stopper.

15. The method of retrofitting a soft-close system to an existing sliding door according to claim 14 further comprising fitting the soft-close device at least partially withing a guiding channel of the support rail for a roller.

16. The method of retrofitting a soft-close system to an existing sliding door according to claim 14 further comprising the preliminary step of removing an existing sliding door panel from the support rail before securing the at least one soft-close bracket to the door panel.

17. The method of retrofitting a soft-close system to an existing sliding door according to claim 16 further comprising the preliminary step removing an existing retainer secured within the support rail before removing the existing sliding door panel.

18. The method of retrofitting a soft-close system to an existing sliding door according to claim 17 further comprising the steps of rehanging the sliding door panel after securing the soft-close bracket to the door panel and reengaging the retainer withing the support rail.

19. The method of retrofitting a soft-close system to an existing sliding door according to claim 14 wherein the step of securing at least one soft-close door stopper to the support rail comprises drilling a hole through the support rail and securing a soft-close door stopper through the hole.

20. The method of retrofitting a soft-close system to an existing sliding door according to claim 19 further comprising drilling two holes for securing two door stoppers.
